(19) United States
(12) Patent Application Publication
(10) Pub. No.: US 2018/0317016 A1
(43) Pub. Date: Nov. 1, 2018

(54) METHOD OF MANUFACTURING SOUND-GENERATING APPARATUS

(71) Applicant: ALPS ELECTRIC CO., LTD., Tokyo (JP)

(72) Inventors: Daigo Aoki, Niigata-ken (JP); Taishi Numata, Niigata-ken (JP); Kiyoshi Sato, Niigata-ken (JP)

(21) Appl. No.: 16/014,803

(22) Filed: Jun. 21, 2018

Related U.S. Application Data
(63) Continuation of application No. PCT/JP2016/079972, filed on Oct. 7, 2016.

(30) Foreign Application Priority Data
Dec. 28, 2015 (JP) 2015-255982

(51) Int. Cl. H04R 11/02; H04R 31/00

(52) U.S. Cl. CPC H04R 11/02; H04R 31/00

(57) ABSTRACT

A magnetic-field-generating unit and a coil vibrates an armature. The armature drives a diaphragm. The armature is formed of a rolled metal plate made of Permalloy. A workpiece is cut out of an unannealed metal plate with a wire saw or by etching such that the long-side direction of the workpiece corresponds to a transverse direction that is orthogonal to the direction of rolling performed on the metal plate. The cut-out workpiece is bent and is then annealed. Through this process, the warp of the armature is minimized.

### CLAIM OF PRIORITY

This application is a Continuation of International Application No. PCT/JP2016/079972 filed on Oct. 7, 2016, which claims benefit of Japanese Patent Application No. 2015-255982 filed on Dec. 28, 2015. The entire contents of each application noted above are hereby incorporated by reference.

### BACKGROUND

### 1. Field of the Disclosure

The present disclosure relates to a method of manufacturing a sound-generating apparatus configured to vibrate a diaphragm by driving an armature made of a magnetic metal plate.

### 2. Description of the Related Art

An arrangement relating to a sound-generating apparatus (an acoustic transducer) is disclosed by Japanese Unexamined Patent Application Publication No. 2012-4850.

This sound-generating apparatus includes a holder frame fixedly provided in a case member. The holder frame has an opening. The opening is closed by a resin film. A diaphragm made of a thin metal plate is pasted to the resin film within the opening.

The holder frame is provided with an armature fixed thereto. The armature includes a vibrating portion and a fixed portion that are integrated with each other. The fixed portion is fixed to the holder frame. The armature is provided with a coil and a yoke fixed thereto. The yoke is provided with two magnets fixed thereto.

The vibrating portion forming a part of the armature is positioned in a void provided in the center of winding of the coil and in the gap between the two magnets. The tip of the vibrating portion and the diaphragm are connected to each other with a beam member.

When the armature of the sound-generating apparatus configured as above is magnetized with a voice current supplied to the coil, the vibrating portion vibrates by the effect of the magnetization and the magnetic field produced by the magnets. The vibration is transmitted through the beam member to the diaphragm, and the diaphragm vibrates, whereby a sound is generated.

In the related-art sound-generating apparatus disclosed by Japanese Unexamined Patent Application Publication No. 2012-4850, the armature is formed of a magnetic metal plate. Such a metal plate has an adjusted thickness by being rolled in one axial direction.

The vibrating portion of the armature has an elongated shape. If the armature is obtained by cutting the metal plate such that the long-side direction of the vibrating portion corresponds to the direction of rolling performed on the metal plate, the internal stress having been generated in the metal plate during the rolling is released, whereby the metal plate warps. In such a state, it is difficult to appropriately set the gap between the vibrating portion and each of the magnets.

The magnetic permeability of the magnetic metal material can be increased by annealing. If an armature is cut out of a metal plate after the metal plate is annealed, the internal stress generated after the annealing makes the warp of the cut-out armature greater.

### SUMMARY

According to an aspect of the present invention, there is provided a method of manufacturing a sound-generating apparatus including an armature made of a magnetic material and that vibrates in a plate-thickness direction with a base portion of the armature being supported, a drive mechanism that vibrates the armature, and a diaphragm that is vibrated by the armature. The method includes forming the armature into an elongated shape from a rolled magnetic metal plate such that a long-side direction of the armature corresponds to a direction intersecting a direction of rolling performed on the metal plate.

A magnetic material can have higher magnetic permeability by being annealed. Accordingly, if the armature having cut out of a metal plate is annealed, the warp of the armature can further be reduced. Moreover, in the case of an armature including a bent portion, if the armature is annealed after being cut out of the metal plate and being bent, the warp of the armature can further be reduced.

### BRIEF DESCRIPTION OF THE DRAWINGS

FIG. 1 is an external perspective view of a sound-generating apparatus according to a first embodiment of the present invention;

FIG. 2 is an exploded perspective view of the sound-generating apparatus illustrated in FIG. 1;

FIG. 3 is a sectional view of the sound-generating apparatus that is taken along line III-III illustrated in FIG. 1;

FIG. 4 is a sectional view of the sound-generating apparatus that is taken along line IV-IV illustrated in FIG. 3, with a case thereof removed;

FIG. 5 is a sectional view of a sound-generating apparatus according to a second embodiment of the present invention;

FIG. 6 is a graph that compares warps of different workpieces obtained by outline machining of different magnetic metal plates;

FIG. 7 is a graph that compares warps of some of the workpieces in different steps of outline machining, bending, and annealing;

FIG. 8 is a graph illustrating measured warps of different workpieces obtained as the “pressed workpiece” listed in Table 1 and plotted in FIG. 6;

FIG. 9 is a graph illustrating measured warps of different armatures obtained through “Step 3” listed in Table 2 and illustrated in FIG. 7;

FIG. 10A is an enlarged view, for reference, of an armature immediately after being machined out of a plate such that the long-side direction thereof corresponds to the transverse direction (TD); and

FIG. 10B is an enlarged view, for reference, of an armature that has been annealed.

### DESCRIPTION OF THE EXAMPLARY EMBODIMENTS

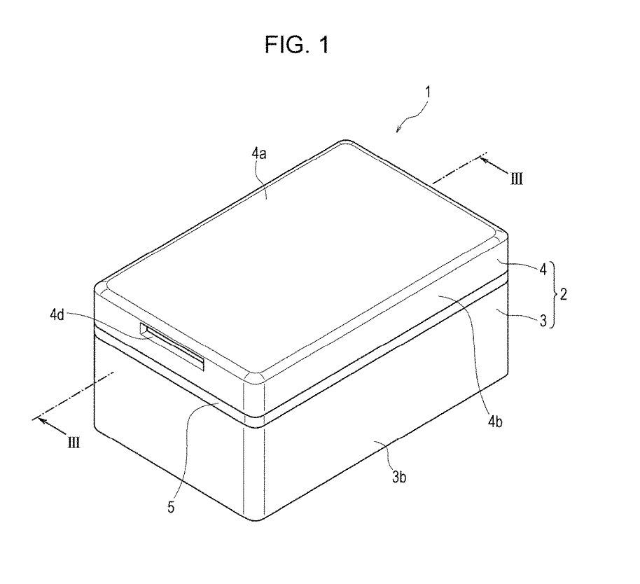

FIGS. 1 to 4 illustrate a sound-generating apparatus 1 according to a first embodiment of the present invention.

The sound-generating apparatus 1 includes a case 2. The case 2 includes a lower case 3 and an upper case 4. The lower case 3 and the upper case 4 are each made of synthetic resin or nonmagnetic metal.

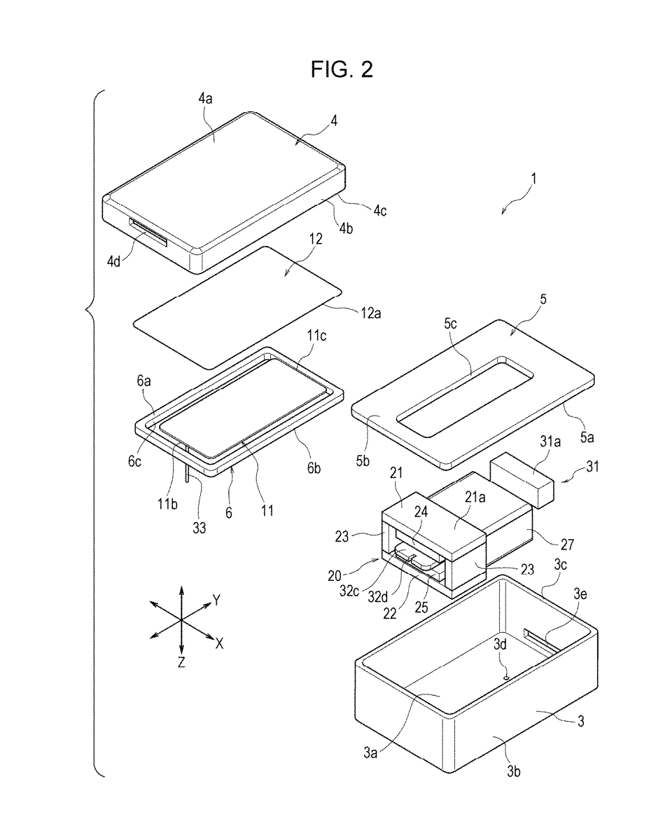

Referring to FIG. 2, the lower case 3 has a bottom part 3a, a sidewall part 3b forming the four side faces, and an opening edge 3c at the upper end of the sidewall part 3b. The upper case 4 has a top part 4a, a sidewall part 4b forming the four side faces, and an opening edge 4c at the lower end of the sidewall part 4b. The space in the lower case 3 is larger than the space in the upper case 4. The upper case 4 serves as a lid for the lower case 3.

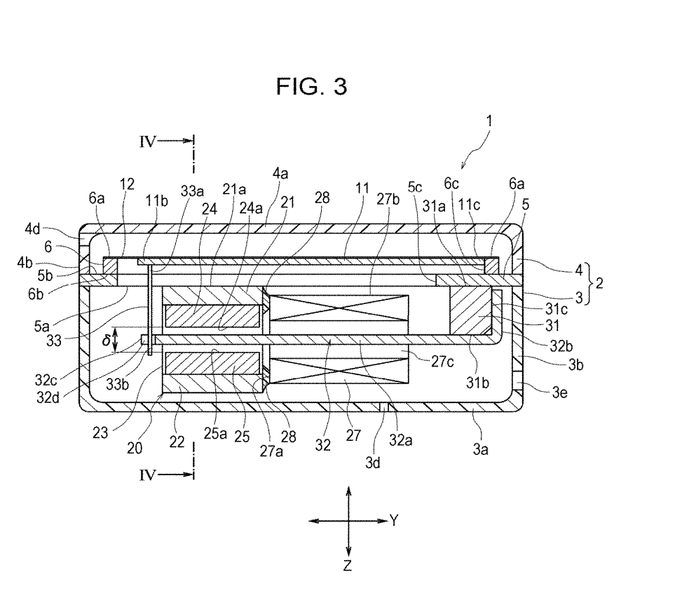

Referring to FIG. 3, a driving-side frame 5 is held between the opening edge 3c of the lower case 3 and the opening edge 4c of the upper case 4. The lower case 3, the upper case 4, and the driving-side frame 5 are fixed to one another with adhesive or the like.

Referring to FIG. 2, the driving-side frame 5 is a plate having a uniform thickness in the Z direction. The driving-side frame 5 has a driving-side attaching surface 5a on the lower side in FIG. 2 and a joining surface 5b on the upper side in FIG. 2. The driving-side frame 5 has a driving-side opening 5c provided in a central part thereof and extending vertically therethrough. The driving-side frame 5 is a magnetic metal plate made of SUS430 (18-chrome stainless steel), cold-rolled steel such as SPCC, or the like.

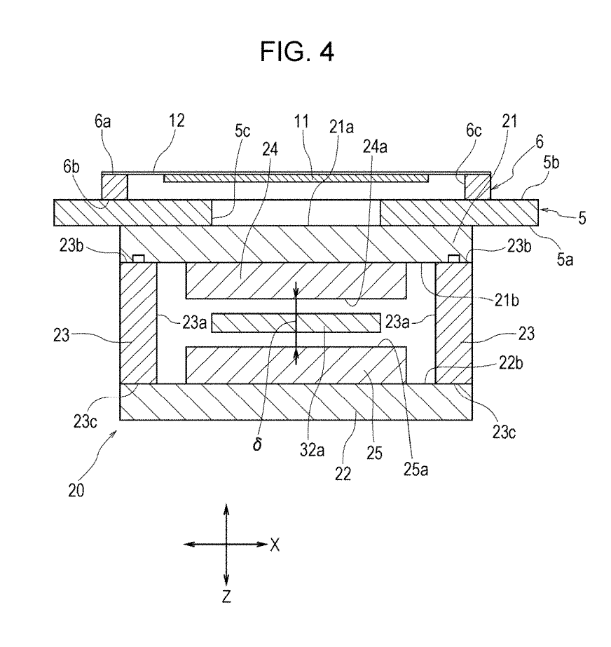

A vibrating-side frame 6 is provided on the upper side of the driving-side frame 5 in FIG. 2. As illustrated in FIGS. 2 and 4, the vibrating-side frame 6 has a frame shape having a wide vibrating-side opening 6c in a central part thereof. A frame part of the vibrating-side frame 6 has a uniform thickness in the Z direction and has a vibrating-side attaching surface 6a on the upper side thereof and a joining surface 6b on the lower side thereof in the drawings. The vibrating-side frame 6 is a nonmagnetic metal plate made of SUS304 (18-chrome 8-nickel stainless steel: 18-8 stainless steel) or the like.

Referring to FIG. 3, the vibrating-side frame 6 is provided on the driving-side frame 5, and the joining surface 5b of the driving-side frame 5 and the joining surface 6b of the vibrating-side frame 6 are joined to each other by surface joining. The driving-side frame 5 and the vibrating-side frame 6 are positioned relative to each other and are fixed to each other in that state by laser welding or with adhesive.

Referring to FIGS. 2 and 3, the vibrating-side frame 6 is provided with a diaphragm 11 and a flexible sheet 12. The diaphragm 11 is made of a thin metal material such as aluminum or SUS304 and has ribs according to need. The ribs are formed by pressing so that the bending strength of the diaphragm 11 is increased. The flexible sheet 12 is easier to bend and deform than the diaphragm 11. The flexible sheet 12 is a resin sheet (a resin film) made of polyethylene terephthalate (PET), nylon, polyester, or the like.

The diaphragm 11 is bonded to the lower surface of the flexible sheet 12 and is thus fixed. An outer peripheral edge 12a (see FIG. 2) of the flexible sheet 12 is fixed to the vibrating-side attaching surface 6a, i.e., the upper surface of the frame part of the vibrating-side frame 6, with adhesive. Hence, the diaphragm 11 is supported by the vibrating-side frame 6 with the aid of the flexible sheet 12 and in a vibratable state.

The diaphragm 11 has a free end 11b and a fulcrum end 11c, which are the ends in the Y direction. The diaphragm 11 is vibratable, with the fulcrum end 11c serving as the fulcrum, such that the free end 11b is displaced in the Z direction.

Referring to FIGS. 2, 3, and 4, the driving-side frame 5 is provided with a magnetic-field-generating unit 20. The magnetic-field-generating unit 20 is an assembly including an upper yoke 21, a lower yoke 22, and a pair of side yokes 23. The upper yoke 21, the lower yoke 22, and the side yokes 23 are each made of a magnetic metal material, for example, cold-rolled steel plate such as SPCC, or a magnetic metal plate of SUS430 (18-chrome stainless steel).

Referring to FIG. 4, the upper yoke 21 and the lower yoke 22 each have a flat shape and face each other with a gap interposed therebetween in the Z direction. A surface of the upper yoke 21 that faces upward in FIG. 4 serves as a joining surface 21a to be joined to the driving-side frame 5. A surface of the upper yoke 21 that faces downward, or inward, in FIG. 4 serves as a counter surface 21b. A surface of the lower yoke 22 that faces upward, or inward, in FIG. 4 serves as a counter surface 22b.

The side yokes 23 each have a flat shape with the same thickness as the upper yoke 21 and the lower yoke 22. A surface of each of the side yokes 23 that faces the other of the side yokes 23 serves as a side counter surface 23a. The side counter surfaces 23a of the respective side yokes 23 are parallel to each other and are each perpendicular to the counter surfaces 21b and 22b of the upper yoke 21 and the lower yoke 22. The side yokes 23 face each other with a gap interposed therebetween in the X direction.

Upper end faces 23b of the respective side yokes 23 are in contact with the counter surface 21b of the upper yoke 21 and are fixed thereto by laser welding or bonding. Lower end faces 23c of the respective side yokes 23 are in contact with the counter surface 22b of the lower yoke 22 and are fixed thereto by laser welding or bonding.

In the magnetic-field-generating unit 20, an upper magnet 24 is fixed to the counter surface 21b of the upper yoke 21, and a lower magnet 25 is fixed to the counter surface 22b of the lower yoke 22. A lower surface 24a of the upper magnet 24 and an upper surface 25a of the lower magnet 25A face each other with a gap δ in the Z direction interposed therebetween. The magnets 24 and 25 are magnetized such that the lower surface 24a of the upper magnet 24 and the upper surface 25a of the lower magnet 25 have opposite polarity with respect to each other.

The joining surface 21a, i.e., the upper surface, of the upper yoke 21 is flat. As illustrated in FIG. 4 and others, the joining surface 21a is joined to the driving-side attaching surface 5a, i.e., the lower surface, of the driving-side frame 5 by surface joining and is fixed thereto by laser welding or with adhesive.

Referring to FIGS. 2 and 3, a coil 27 is provided next to the magnetic-field-generating unit 20. The coil 27 includes a conducting wire wound around a winding-center line extending in the Y direction. A vibrating portion 32a of an armature 32 is positioned in a space 27c provided in the center of winding of the coil 27. The conducting wire of the coil 27 is wound in such a manner as to encircle the armature 32.

An end face of the coil 27 that faces toward the left side in the Y direction serves as a joining surface 27a. The joining surface 27a is fixed to the upper yoke 21 and the lower yoke 22 of the magnetic-field-generating unit 20 with respective adhesive layers 28 interposed therebetween. In fixing the joining surface 27a to the magnetic-field-generating unit 20, the coil 27 and the magnetic-field-generating unit 20 are positioned such that the winding-center line of the coil 27 coincides with the center of the 6 between the upper magnet 24 and the lower magnet 25.

In the first embodiment, the magnetic-field-generating unit 20 and the coil 27 form a drive mechanism that vibrates the armature 32.

Referring to FIG. 3, a supporting member 31 is fixed to the driving-side attaching surface 5a, i.e., the lower surface, of the driving-side frame 5. The supporting member 31 has an upper surface 31a, a lower surface 31b, and a rear end surface 31c. The upper surface 31a and the lower surface 31b are flat surfaces that are parallel to each other. The rear end surface 31c is perpendicular to the upper surface 31a. The upper surface 31a of the supporting member 31 is joined to the driving-side attaching surface 5a by surface joining and is fixed thereto by laser welding or the like.

The armature 32 is attached to the lower surface 31b of the supporting member 31. The armature 32 and the supporting member 31 are each made of a magnetic material. The supporting member 31 is made of cold-rolled steel such as SPCC or SUS430 (18-chrome stainless steel). The armature 32 is made of a Ni—Fe alloy (Permalloy), which is a magnetic material.

Referring to FIG. 3, the armature 32 includes the vibrating portion 32a, a base portion 32b extending substantially perpendicularly from the vibrating portion 32a, and a tip portion 32c. The tip portion 32c has a recess 32d at the widthwise center thereof.

The base portion 32b of the armature 32 is joined to the rear end surface 31c of the supporting member 31 by surface joining and is fixed thereto by laser welding or the like. As illustrated in FIG. 3, the vibrating portion 32a is positioned in the space 27c provided in the center of winding of the coil 27 and in the gap δ between the upper magnet 24 and the lower magnet 25. The tip portion 32c of the armature 32 projects from the gap δ frontward in the Y direction.

As illustrated in FIG. 3, the free end 11b of the diaphragm 11 and the tip portion 32c of the armature 32 are connected to each other with a transmitting member 33. The transmitting member 33 is a needle-like member made of metal or synthetic resin. A fixed portion 33a of the transmitting member 33 that is at the upper end is fixed to the diaphragm 11. A connecting end 33b of the transmitting member 33 that is at the lower end extends through the recess 32d of the armature 32. The connecting end 33b and the armature 32 are fixed to each other with adhesive.

The armature 32 is a plate made of a Ni—Fe alloy (Permalloy). The plate has been rolled in one axial direction between rollers so that the thickness thereof is made uniform. Hereinafter, the direction in which the plate is rolled is referred to as “machining direction” and is abbreviated to MD, and a direction orthogonal to the MD is referred to as “transverse direction” and is abbreviated to TD. The armature 32 has an elongated shape with the length thereof in the Y direction being generally greater than the width thereof in the X direction. The long-side direction (the Y direction) of the armature 32 corresponds to the TD.

A rolled metal plate has an internal stress accumulated in the rolling process. Therefore, when such a metal plate is cut into pieces each having the size of the armature 32, the internal stress is released, whereby the plate warps. The warp occurs greater in the MD than in the TD. Hence, if the plate is machined for outlining the armature 32 such that the TD corresponds to the long-side direction of the armature 32, the warp of the resulting armature 32 in the long-side direction that tends to occur immediately after the machining of the plate can be reduced.

A magnetic metal material such as Permalloy can have increased magnetic permeability by being annealed. However, if a large rolled plate is annealed first, the internal stress generated therein further increases. Accordingly, if such a large rolled plate is cut into pieces of armatures 32 after being annealed, the internal stress generated in the annealing is also released. Consequently, the warp becomes greater. Hence, to obtain the armature 32, it is preferable to first cut a plate into pieces of armatures 32 such that the long-side direction of each armature 32 corresponds to the TD, to then bend the armature 32 in such a manner as to form a base portion 32b, and to then anneal the bent armature 32. If a flat armature 32 that does not need to be bent to form the base portion 32b is employed, it is preferable to first cut a plate into pieces of armatures 32 such that the long-side direction of each armature 32 corresponds to the TD, and to then anneal the armature 32.

If a rolled metal plate is cut into pieces of elongated but small armatures 32 and the armatures 32 are then annealed, the accumulation of internal stress during the annealing can be reduced. Accordingly, such armatures 32 have substantially no warp caused by annealing.

In the outline machining of a rolled plate for obtaining armatures 32, it is preferable to employ a cutting method that causes less damage during the machining. For example, it is preferable to machine the outline of each armature 32 by using a wire saw or by etching. If armatures 32 are machined out of a plate with a wire saw or by etching, the increase in the warp that may be caused by outline machining can be suppressed.

An armature 32 obtained by outline machining of a plate such that the long-side direction thereof corresponds to the TD and that is annealed after the outline machining can have a reduced warp in the long-side direction (the Y direction) of the vibrating portion 32a thereof. Hence, when the armature 32 is assembled with other elements, the tip portion 32c thereof can be easily positioned at the center of the gap δ between the upper magnet 24 and the lower magnet 25. Therefore, the assembling work and the adjustment work are facilitated, and a sound-generating apparatus 1 with high dimensional accuracy can be obtained.

Referring to FIG. 3, since the lower case 3 and the upper case 4 are fixed to each other with the driving-side frame 5 interposed therebetween, the space in the case 2 is divided into upper and lower spaces by the diaphragm 11 and the flexible sheet 12. The space above the diaphragm 11 and the flexible sheet 12 and in the upper case 4 serves as a sound-generating space. The sound-generating space communicates with the outside through a sound-generating port 4d provided in the sidewall part 4b of the upper case 4. The bottom part 3a of the lower case 3 has an exhaust port 3d, through which the space below the diaphragm 11 and the flexible sheet 12 and in the lower case 3 communicates with the outside.

The sidewall part 3b of the lower case 3 has a wiring hole 3e through which a wiring line that conducts electricity to the coil 27 is drawn to the outside.

Now, the operation of the sound-generating apparatus 1 will be described.

When a voice current is supplied to the coil 27, the armature 32 is induced to produce a magnetic field. The magnetic field produced by the armature 32 and the magnetic field produced in the gap δ between the upper magnet 24 and the lower magnet 25 cause the vibrating portion 32a of the armature 32 to vibrate in the Z direction. The vibration is transmitted through the transmitting member 33 to the diaphragm 11, whereby the diaphragm 11 vibrates. Specifically, the diaphragm 11 supported by the flexible sheet 12 vibrates such that the free end 11b thereof vibrates in the Z direction with the fulcrum end 11c thereof serving as the fulcrum. The vibration of the diaphragm 11 generates a sound pressure in the sound-generating space of the upper case 4, and the sound pressure is outputted to the outside through the sound-generating port 4d.

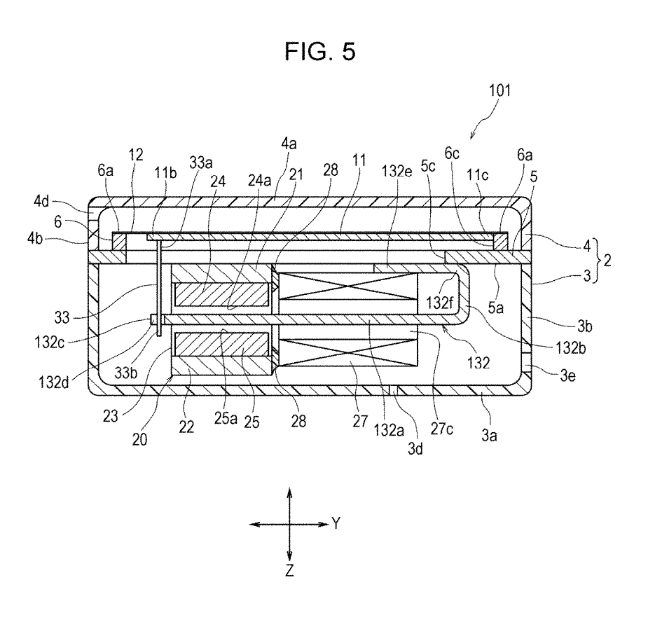

FIG. 5 illustrates a sound-generating apparatus 101 according to a second embodiment of the present invention.

The sound-generating apparatus 101 has the same configuration as the sound-generating apparatus 1 according to the first embodiment, except the configuration of the armature.

An armature 132 employed in the sound-generating apparatus 101 includes a vibrating portion 132a, a folded U portion 132b at the base end of the vibrating portion 132a, and a fixed portion 132e continuous with the folded U portion 132b. The vibrating portion 132a, the folded U portion 132b, and the fixed portion 132e are integrated with one another. The armature 132 is folded such that the fixed portion 132e extends parallel to the vibrating portion 132a. A tip portion 132c of the armature 132 has a recess 132d.

The sound-generating apparatus 101 does not include the supporting member 31. The fixed portion 132e of the armature 132 is directly fixed to the driving-side attaching surface 5a of the driving-side frame 5. The armature 132 is elastically deformable from a boundary 132f between the folded U portion 132b and the fixed portion 132e to the tip portion 132c. Therefore, the armature 132 is vibratable with a large displacement. Accordingly, the diaphragm 11 can have a large amplitude, whereby the sound to be outputted is increased.

The armature 132 of the sound-generating apparatus 101 illustrated in FIG. 5 is also obtained by cutting a Permalloy plate with a wire saw or by etching such that the long-side direction of the armature 132 corresponds to the TD (the Y direction). Then, the armature 132 is folded at the base portion to form the folded U portion 132b and the fixed portion 132e, and is annealed.

### Examples

Table 1 below summarizes the results of measurement of warps occurred in a pressed workpiece and Workpieces 1 to 8.

The pressed workpiece listed in Table 1 is a basic example for comparison with examples according to the present invention and was obtained through a pressing process in which a workpiece having a width of 1 mm and a length of 5.5 mm was machined out of a rolled metal plate made of Permalloy and having a thickness of 0.15 mm. The long-side direction of the workpiece corresponded to the MD. This workpiece was bent perpendicularly to form a base portion 32b as illustrated in FIG. 3, whereby the workpiece was obtained as an armature. Subsequently, the workpiece was annealed by being heated to 1100° C. in a hydrogen atmosphere.

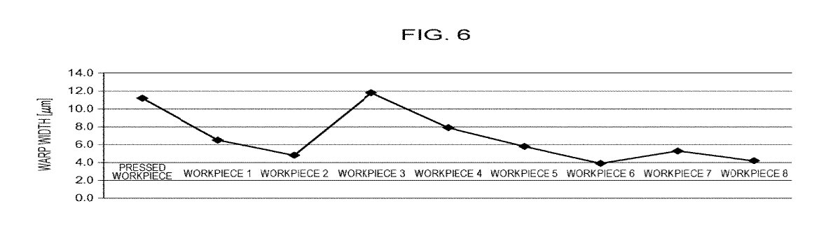

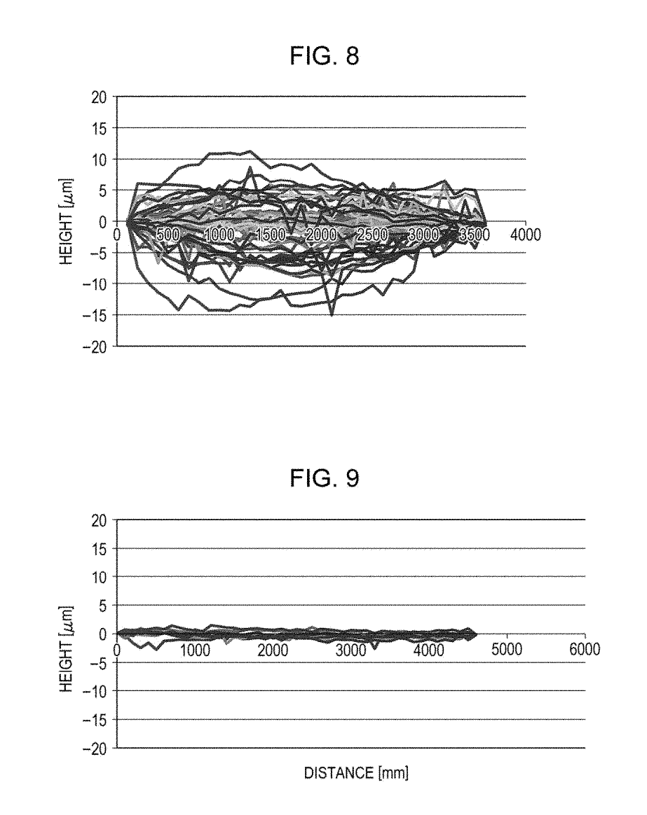

Table 1 summarizes measured values defining a warp occurred in the vibrating portion of the pressed workpiece (armature) obtained as above. The warp was measured with a laser displacement meter. FIG. 8 is a graph of measured displacements from a center line extending in the Y direction for a plurality of workpieces each prepared as the pressed workpiece. As can be seen from Table 1, the average displacement on the positive side was 5.6 μm, the average displacement on the negative side was 5.6 μm, and the average warp width was 11.2 μm. The average warp width of 11.2 μm is plotted for the pressed workpiece in the graph illustrated in FIG. 6.

Workpieces 1 to 8 listed in Table 1 were each obtained by cutting a rolled metal plate made of Permalloy and having a thickness of 0.15 mm into pieces each having a width of 1 mm and a length of 5.5 mm by a cutting method that causes less damage. In the cutting process, the outlines of Workpieces 1 to 4 were machined with a wire saw, and the outlines of Workpieces 5 to 8 were machined by etching.

Workpiece 1 was not annealed before the outline thereof was machined with the wire saw. The long-side direction of Workpiece 1 corresponded to the MD. Workpiece 2 was not annealed before the outline thereof was machined with the wire saw. The long-side direction of Workpiece 2 corresponded to the TD. Workpiece 3 was annealed before the outline thereof was machined with the wire saw. In the annealing process, Workpiece 3 was heated to 1100° C. in a hydrogen atmosphere. The long-side direction of Workpiece 3 corresponded to the MD. Workpiece 4 was annealed before the outline thereof was machined with the wire saw. The long-side direction of Workpiece 4 corresponded to the TD.

Workpiece 5 was not annealed before the outline thereof was machined by etching. The long-side direction of Workpiece 5 corresponded to the MD. Workpiece 6 was not annealed before the outline thereof was machined by etching. The long-side direction of Workpiece 6 corresponded to the TD. Workpiece 7 was annealed before the outline thereof was machined by etching. In the annealing process, Workpiece 7 was heated to 1100° C. in a hydrogen atmosphere. The long-side direction of Workpiece 7 corresponded to the MD. Workpiece 8 was annealed before the outline thereof was machined by etching. The long-side direction of Workpiece 8 corresponded to the TD.

TABLE 1

| | | Annealing | | Annealing | Warp [μm] | | |
|---|---|---|---|---|---|---|---|
| | Machining | before | Machining | after | | | Warp |
| | method | machining | direction | bending | Pos. side | Neg. side | width |
| Pressed | Pressing | — | MD | Yes | 5.6 | −5.6 | 11.2 |
| workpiece | | | | | | | |
| Workpiece 1 | Wire saw | No | MD | — | 3.2 | −3.3 | 6.5 |
| Workpiece 2 | | No | TD | — | 2.4 | −2.4 | 4.8 |
| Workpiece 3 | | Yes | MD | — | 5.6 | −6.2 | 11.8 |
| Workpiece 4 | | Yes | TD | — | 3.4 | −4.5 | 7.9 |
| Workpiece 5 | Etching | No | MD | — | 3.8 | −2 | 5.8 |
| Workpiece 6 | | No | TD | — | 2 | −1.9 | 3.9 |
| Workpiece 7 | | Yes | MD | — | 2.8 | −2.5 | 5.3 |
| Workpiece 8 | | Yes | TD | — | 2.2 | −2 | 4.2 |

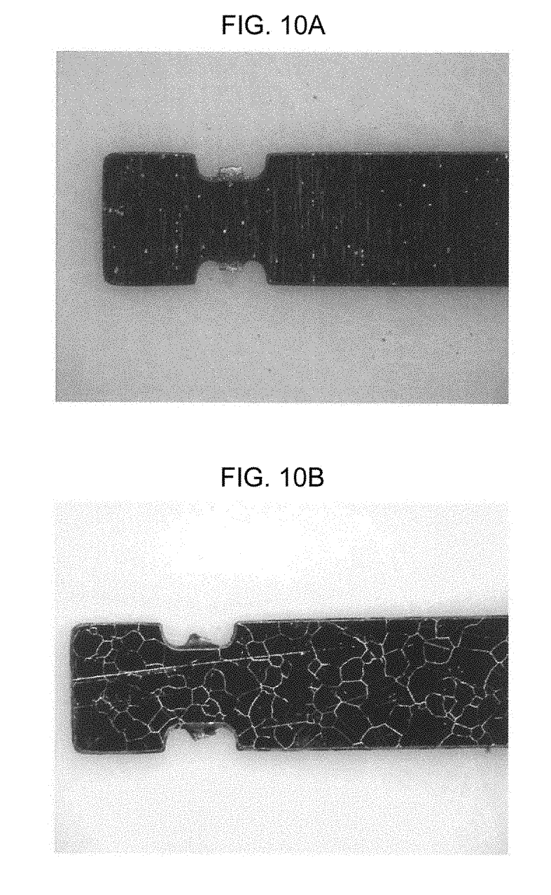

FIGS. 10A and 10B are each an enlarged photograph of a plate surface for reference. FIG. 10A shows the surface of Workpiece 6, that is, the surface of a workpiece that was machined out by etching without being annealed and whose long-side direction corresponded to the TD. FIG. 10B shows the surface of Workpiece 8, that is, the surface of a workpiece that was machined out by etching after being annealed and whose long-side direction corresponded to the TD.

The average warp widths of Workpieces 1 to 8 summarized in Table 1 are plotted in the graph illustrated in FIG. 6, along with the average warp width of the pressed workpiece.

As can be seen from Table 1 and FIG. 6, among the workpieces that were machined out with the wire saw, Workpiece 2 obtained without being annealed before being machined out and whose long-side direction corresponded to the TD had the smallest warp. Likewise, among the workpieces that were machined out by etching, Workpiece 6 obtained without being annealed before being machined out and whose long-side direction corresponded to the TD had the smallest warp.

The magnetic metal plate after being rolled has a residual stress thereinside. If a workpiece of size 1 mm by 5.5 mm, for example, is machined out of such a magnetic metal plate, the internal stress is released, and the workpiece is therefore likely to warp. Such a warp tends to be greater in the MD. Therefore, orienting the workpiece such that the long-side direction thereof corresponds to the TD can reduce the size of the warp. On the other hand, the magnetic permeability of a magnetic metal plate is improved by annealing. However, if a plate having a large area is annealed, the internal stress that remains in the plate also becomes large. Therefore, it is preferable not to anneal the plate before a workpiece is machined out.

Table 2 below summarizes the average warp widths of a plurality of samples measured as Workpiece 2, that is, samples that were machined out with the wire saw without being annealed and such that the long-side direction thereof corresponded to the TD. The samples include those for “Step 1” that were subjected to measurement immediately after the outline machining, those for “Step 2” that were subjected to measurement after the machined workpieces were each bent substantially perpendicularly at a base portion as illustrated in FIG. 3, and those for “Step 3” that were subjected to measurement after the bending and the annealing.

Table 2 also summarizes the average warp widths of a plurality of samples measured as Workpiece 4, that is, samples that were machined out with the wire saw after being annealed and such that the long-side direction thereof corresponded to the TD. The samples include those for “Step A” that were subjected to measurement immediately after the outline machining, and those for “Step B” that were subjected to measurement after the machined workpiece is bent substantially perpendicularly at a base portion as illustrated in FIG. 3.

TABLE 2

| | | | Warp [μm] | | |
|---|---|---|---|---|---|
| | | | Pos. side | Neg. side | Warp width |
| Workpiece 2 | Step 1 | Outline | 2.1 | −2.6 | 4.7 |
| | | machining | | | |
| | Step 2 | Bending | 2.0 | −2.1 | 4.1 |
| | Step 3 | Annealing | 1.2 | −1.4 | 2.6 |
| Workpiece 4 | Step A | Outline | 4.4 | −4.1 | 8.6 |
| | | machining | | | |
| | Step B | Bending | 2.7 | −2.6 | 5.2 |

FIG. 9 is a graph of displacements of a plurality of armatures obtained after “Step 3” that were measured with reference to the center line extending in the Y direction and with a laser displacement meter.

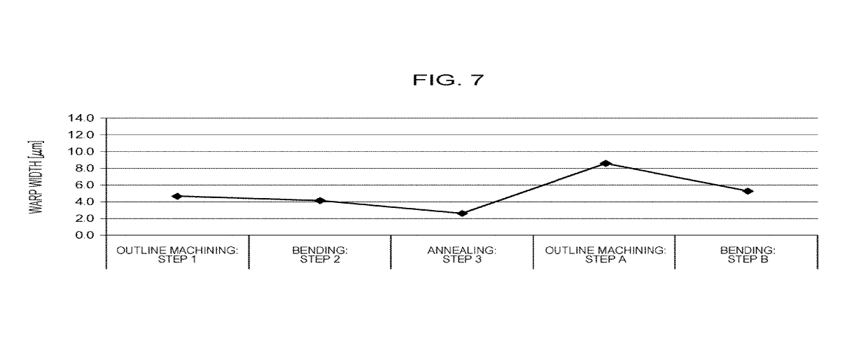

The average warp widths measured in “Step 1,” “Step 2,” “Step 3,” “Step A,” and “Step B” are plotted in the graph illustrated in FIG. 7.

As summarized for Step 3, it is found to be preferable to employ an armature obtained by machining a workpiece out of an unannealed metal plate and then annealing the workpiece after bending the workpiece. Even if an armature including no bent portion is employed, the armature is preferably machine out of an unannealed metal plate.

What is claimed is:

1. A method of manufacturing a sound-generating apparatus including an armature made of a magnetic material and that vibrates in a plate-thickness direction with a base portion of the armature being supported, a drive mechanism that vibrates the armature, and a diaphragm that is vibrated by the armature, the method comprising:
providing a rolled magnetic metal plate, the rolled magnetic metal plate having a direction of rolling performed on the metal plate;
forming the armature into an elongated shape from the rolled magnetic metal plate such that a long-side direction of the armature corresponds to a direction intersecting the direction of rolling performed on the metal plate.

2. The method according to claim 1, wherein the armature is formed into the elongated shape by cutting the armature out of the metal plate.

3. The method according to claim 2, further comprising annealing the armature after the armature is cut out of the metal plate.

4. The method according to claim 2, further comprising bending the metal plate and annealing the armature after the armature is cut out of the metal plate.

5. The method according to claim 1, wherein the armature is formed into the elongated shape by cutting the armature out of the metal plate with a wire saw.

6. The method according to claim 1, wherein the armature is formed into the elongated shape by cutting the armature out of the metal plate by etching.
